(19) United States
(12) Patent Application Publication
(10) Pub. No.: US 2026/0140325 A1
(43) Pub. Date: May 21, 2026

(54) PROTECTOR FOR SMALL FORM FACTOR PLUGGABLE CONNECTORS

(71) Applicant: AT&T Intellectual Property I, L.P., Atlanta, GA (US)

(72) Inventors: Bhushan Padhiar, Frisco, TX (US); Stewart Barker, Lucas, TX (US)

(21) Appl. No.: 18/952,817

(22) Filed: Nov. 19, 2024

(51) Int. Cl. G02B 6/38

(52) U.S. Cl. CPC G02B 6/3814; G02B 6/387

(57) ABSTRACT

Examples of the present disclosure provide a mechanical protector or guard that fits around a portion of a small form factor pluggable (SFP) connector. In one example, an apparatus includes a tube. The tube includes an inner perimeter sized to fit snugly around a tail of a small form factor pluggable connector and an outer perimeter. At least one of: the inner perimeter or the outer perimeter is engraved with a lattice pattern, the lattice pattern being configured to dissipate heat.

The present disclosure relates generally to fiber broadband network infrastructure, and relates more particularly to an apparatus for preventing user injury from small form factor pluggable connectors.

### BACKGROUND

Fiber broadband is a type of network architecture that uses optical fiber to provide all or part of the local loop used for last mile telecommunications. Small form factor pluggable (SFP) connectors are used in fiber broadband networks to connect customers'Internet hubs (e.g., data centers, central offices, residential gateways, etc.) to the fiber broadband network service provider's fiber lines. SFP is a compact, hot-pluggable network interface module format used for both telecommunication and data communications applications.

### SUMMARY

Examples of the present disclosure provide a mechanical protector or guard that fits around an SFP connector. In one example, an apparatus includes a tube. The tube includes an inner perimeter sized to fit snugly around a tail of a small form factor pluggable connector and an outer perimeter. At least one of: the inner perimeter or the outer perimeter is engraved with a lattice pattern, the lattice pattern being configured to dissipate heat.

In another example, an apparatus includes a first arm having a c-shaped cross section, a second arm having a c-shaped cross section, a hinge connecting an end of the first arm to an end of the second arm, and a latch positioned on at least one of: a free end of the first arm and a free end of the second arm. A rectangular tube is formed when the free end of the first arm is pivoted, via the hinge, toward the free end of the second arm. At least one of: an inner perimeter of the rectangular tube or an outer perimeter of the rectangular tube is engraved with a hexagonal lattice pattern, the hexagonal lattice pattern being configured to dissipate heat.

In another example, an apparatus includes a small form factor pluggable connector for connecting an optical fiber to a small form factor socket and a protector fitted around at least a portion of the small form factor pluggable connector. The protector includes a tube, the tube having an inner perimeter sized to fit snugly around the at least the portion of the small form factor pluggable connector, and an outer perimeter. At least one of: the inner perimeter or the outer perimeter is engraved with a lattice pattern, the lattice pattern being configured to dissipate heat.

### BRIEF DESCRIPTION OF THE DRAWINGS

The teachings of the present disclosure can be readily understood by considering the following detailed description in conjunction with the accompanying drawings, in which:

FIG. 1A illustrates a cross sectional view of an example protector for preventing user injury from small form factor pluggable connectors, according to the present disclosure;

FIG. 1B illustrates an isometric view of the protector of FIG. 1A fitted onto the tail of the small form factor pluggable connector of FIG. 1A; and

FIG. 2 illustrates a portion of a hexagonal lattice pattern that may be formed on the inner perimeter of the protector illustrated in FIGS. 1A and 1B.

To facilitate understanding, identical reference numerals have been used, where possible, to designate identical elements that are common to the figures.

### DETAILED DESCRIPTION

In one example, the present disclosure provides an apparatus for preventing user injury from small form factor pluggable connectors. As discussed above, fiber broadband is a type of network architecture that uses optical fiber to provide all or part of the local loop used for last mile and transport telecommunications. Small form factor pluggable (SFP) connectors are used in fiber broadband networks to connect customers'Internet hubs (e.g., data centers, central offices, residential gateways, etc.) to the fiber broadband network service provider's fiber lines. SFP connectors may also be used to connect Layer 2 and Layer 3 switches and routers, mobility small cell, macro cell, and/or other mobility radios. SFP is a compact, hot-pluggable network interface module format used for both telecommunication and data communications applications.

An SFP connector is typically made up of multiple components, including a transmitter optical sub-assembly, a receiver optical sub-assembly, a bi-directional optical sub-assembly, and other components mounted on a printed circuit board (PCB). Some SFP connectors may also include an on-board optical network terminal (ONT), which may add to the heat generated by the SFP connector. These components tend to generate a lot of heat in operation, which makes the tail of the SFP connector (e.g., the portion of the SFP connector that resides outside of the network equipment and connects directly to the fiber) very hot. In some cases, the tail of the SFP connector may be hot enough to cause injury to a person (e.g., customer, technician, or the like) who handles or otherwise comes into physical contact with the SFP connector.

Examples of the present disclosure provide a mechanical protector or guard that fits around at least a portion of (e.g., at least the tail of) an SFP connector and is designed to dissipate heat generated by components of the SFP connector. The protector may act as a thermal jacket that dissipates enough heat so that the SFP connector can be safely handled manually. In addition, by dissipating heat from the SFP connector, the functional lifetime of the SFP connector may be extended by minimizing heat-related damage to the SFP connector and fiber. Moreover, the protector may minimize mechanical damage to the fragile SFP connector and fiber caused by mishandling (e.g., by a customer, a technician, or the like) and contact with hard surfaces.

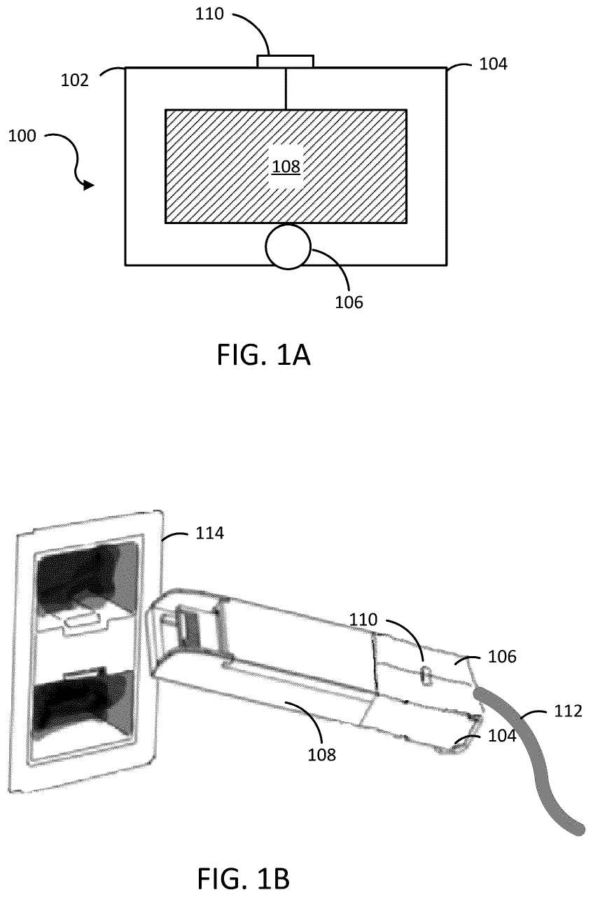

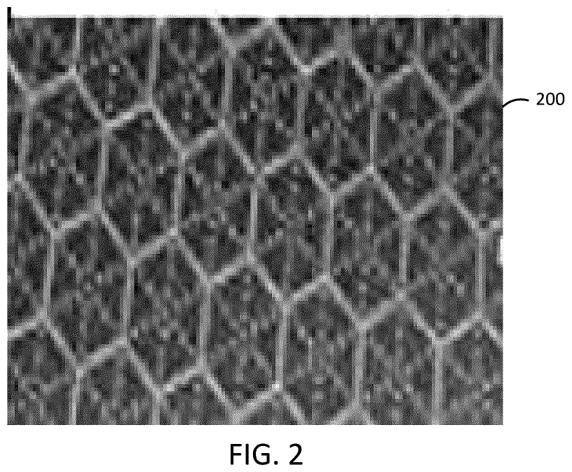

Examples of the present disclosure may be adapted to any form factor of SFP and quad SFP (QSFP) connector, including enhanced SFP (SFP+), SFP 56, SFP 112, SFP 256, QSFP 56, and other form factors of SFP connectors, including double density. These and other aspects of the present disclosure are discussed in further detail with reference to FIGS. 1A-2, below.

To further aid in understanding the present disclosure, FIG. 1A illustrates a cross sectional view of an example protector 100 for preventing user injury from small form factor pluggable connectors, according to the present disclosure. In one example, the protector 100 is sized to fit around at least the tail of an SFP connector 108. FIG. 1B illustrates an isometric view of the protector 100 of FIG. 1A fitted onto the tail of the small form factor pluggable connector 108 of FIG. 1A.

The cross section of the protector 100 may generally comprise a rectangular ring. Thus, the outside perimeter of the first protector 100 may comprise four sides, and the size of the outside perimeter may be of any size. The inside perimeter of the protector 100 may comprise four sides and may be of a size that is smaller than the size of the outside perimeter. In one example, the inside perimeter of the protector 100 is slightly larger than a perimeter of an SFB connector tail, so that the tail of the SFB connector 108 may fit securely within the protector 100. A length of the protector 100 may be at least as long as the tail of a standard SFP connector, so that the entirety of the tail can fit within the protector 100, leaving little to no exposed surface to potentially burn a user. Thus, the protector 100 may resemble a short rectangular tube.

In one example, the rectangular tube of the protector 100 may be formed as a first arm 102 and a second arm 104. Each of the first arm 102 and the second arm 104 may have a C-shaped cross section. The first arm 102 and the second arm 104 may be joined at a hinge 106 (e.g., one end of the first arm 102 may be joined to one end of the second arm 104 at the hinge 106). The hinge 106 may allow the protector 100 to be opened (e.g., by pivoting the free ends, or the ends not joined at the hinge, of the first arm 102 and the second arm 104 away from each other) to insert the tail of the SFP protector 100, and then allow the protector 100 to be closed snugly around the tail (e.g., by pivoting the free ends of the first arm 102 and the second arm 104 toward each other).

In one example, the protector 100 may further include a latch 110. The latch 110 may be positioned on an opposite side of the rectangular ring from the hinge 106. The latch 110 may comprise any type of fastening mechanism that holds the protector 100 in a closed position when the protector 100 is fitted around the tail of the SFP connector 108. For instance, the latch 110 may comprise a key attached to the first arm 102 that fits within a lock formed in the second arm 104.

In another example, the latch 110 may comprise a magnetic mechanism that pulls the free ends of the first arm 102 and the second arm 104 toward each other. In this case, the magnetic mechanism may be located to minimize any potential interference with signals propagating through the fiber 112 (shown in FIG. 1B) attached to the SFP connector 108. The latch 110 is releasable, so that the protector 100 can be installed on or removed from the tail of the SFP connector 108 at any time. As such, the protector 100 may be installed on the tail of the SFP connector 108 regardless of whether the fiber 112 has already been connected to the SFP connector 108.

As shown in FIG. 1B, once the protector 100 is installed on the tail of the SFP connector 108, the SFP connector 108 may be inserted into an SFP socket 114. When the SFP connector 108 is inserted into the SFP socket 114, the protector 100 may sit flush against the outside of the SFP socket 114 and surround the tail of the SFP connector 108, which protrudes from the SFP socket 114.

The protector 100 may be formed of various materials, including at least one of: a metal, a polymer, or another thermally insulating material that is capable of withstanding deformation when exposed to the levels of heat that may be generated by the components of the SFP connector 108 (e.g., in the range of zero to seventy degrees Celsius for most types and uses of SFP connectors, but some types and uses may fall well below or above this range). Additionally, the material may be relatively lightweight to avoid damaging the fiber 112 (e.g., to avoid damage caused by the fiber 112 supporting the weight of the protector 100).

In one example, at least one of the inner perimeter of the protector 100 (i.e., the surfaces of the rectangular ring that come into direct contact with the tail of the SFP connector 108 when the protector is installed) and the outer perimeter of the protector 100 (i.e., the surfaces of the rectangular ring that a user may come into direct contact with) may be engraved with a lattice pattern. In one example, the lattice pattern may comprise a hexagonal lattice pattern.

FIG. 2, for example, illustrates a portion of a hexagonal lattice pattern 200 that may be formed on the inner perimeter and/or outer perimeter of the protector 100 illustrated in FIGS. 1A and 1B. A lattice pattern may help to dissipate heat from the tail of the SFP connector 108. Experimental results have shown that a hexagonal lattice pattern similar to the pattern 200 illustrated in FIG. 2 dissipates the heat with particular efficiency. Moreover, the lattice pattern may help to form a friction fit with the tail of the SFP connector 108. That is, friction between the tail of the SFP connector 108 and the lattice pattern formed on the inner perimeter of the protector 100 may help to hold the protector 100 in place (e.g., so that the protector 100 does not slide along the SFP connector 108 or fiber 112).

In another example, the lattice pattern may extend through to the outer perimeter of the protector 100, so that the protector 100 includes a plurality of perforations.

Thus, the protector 100 of the present disclosure may help to efficiently dissipate heat from the tail of an SFP connector that is used to connect optical fiber to customer premises equipment, reducing the likelihood of user injury and making the SFP connector safer to handle. In addition, by dissipating heat from the SFP connector, the functional lifetime of the SFP connector may be extended by minimizing heat-related damage to the SFP connector and fiber. Additionally, the protector may minimize mechanical damage to the fragile SFP connector and fiber caused by mishandling (e.g., by a customer, a technician, or the like) and contact with hard surfaces.

The protector 100 may be used in any context where an SFP connector is used, including a wide range of network applications for wireline and wireless networks, customer and enterprise data centers, customer premises, and the like (e.g., optical line terminals, Ethernet multiplexing equipment, broadband network gateways, small cells, baseband units, customer premises equipment, and the like). For instance, the protector 100 may be used to protect 10-Gigabit Symmetric Passive Optical Network (XGS-PON) technology SFPs (e.g., as may be used in a residential gateway), 25 Gigabit Passive Optical Network (25GS) SFP ONTs (e.g., as may be used in next-generation routers), and other equipment.

It should be noted that although the examples described above describe the protector 100 as a rectangular ring or tube, in other examples the protector 100 may take other shapes, such as conical shapes, round or circular tubes, or other shapes and cross sections, where the two arms may have complementary shapes.

In one example, the protector 100 described above may be pre-installed around the tail of an SFP connector such as the SFP connector 108. For instance, when equipment including an SFP connector is shipped to a customer (e.g., for self-installation of the equipment) or installed by a technician, the protector 100 may already be installed on the SFP connector 108 prior to shipment, so that the protector 100 is already positioned to prevent user injury caused by contact with the tail of the SFP connector 108. Alternatively, the protector 100 may be shipped to the customer with the equipment and with instructions for installing the protector 100 to prevent user injury.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. An apparatus comprising:
a tube, the tube comprising:
an inner perimeter sized to fit snugly around a tail of a small form factor pluggable connector; and
an outer perimeter,
wherein at least one of: the inner perimeter or the outer perimeter is engraved with a lattice pattern, the lattice pattern being configured to dissipate heat.

2. The apparatus of claim 1, wherein the tube is formed of a polymer.

3. The apparatus of claim 1, wherein the tube is formed of a metal.

4. The apparatus of claim 1, wherein the tube comprises:
a first arm having a c-shaped cross section;
a second arm having a c-shaped cross section; and
a hinge connecting an end of the first arm to an end of the second arm, so that the tube takes a form of a rectangular tube having four sides when a free end of the first arm is pivoted, via the hinge, toward a free end of the second arm.

5. The apparatus of claim 4, further comprising:
a latch positioned on a side of the four sides that is opposite a side of the four sides on which the hinge is positioned, to hold the tube in a closed position.

6. The apparatus of claim 5, wherein the latch comprises a key formed in the first arm and a lock formed in the second arm.

7. The apparatus of claim 5, wherein the latch comprises a magnet.

8. The apparatus of claim 1, wherein the lattice pattern comprises a hexagonal lattice pattern.

9. The apparatus of claim 1, wherein the lattice pattern is engraved on both of the inner perimeter and the outer perimeter, so that the tube is perforated.

10. An apparatus comprising:
a first arm having a c-shaped cross section;
a second arm having a c-shaped cross section;
a hinge connecting an end of the first arm to an end of the second arm; and
a latch positioned on at least one of: a free end of the first arm and a free end of the second arm,
wherein a rectangular tube is formed when the free end of the first arm is pivoted, via the hinge, toward the free end of the second arm, and
wherein at least one of: an inner perimeter of the rectangular tube or an outer perimeter of the rectangular tube is engraved with a lattice pattern, the lattice pattern being configured to dissipate heat.

11. The apparatus of claim 10, wherein the first arm and the second arm are formed of a polymer.

12. The apparatus of claim 10, wherein first arm and the second arm are formed of a metal.

13. The apparatus of claim 10, wherein the latch is positioned to hold the rectangular tube in a closed position when the rectangular tube is formed.

14. The apparatus of claim 10, wherein the latch comprises a key formed in the first arm and a lock formed in the second arm.

15. The apparatus of claim 10, wherein the latch comprises a magnet.

16. The apparatus of claim 10, wherein the lattice pattern is engraved on both of the inner perimeter and the outer perimeter, so that the rectangular tube is perforated.

17. An apparatus comprising:
a small form factor pluggable connector for connecting an optical fiber to a small form factor socket; and
a protector fitted around at least a portion of the small form factor pluggable connector, the protector comprising:
a tube, the tube comprising:
an inner perimeter sized to fit snugly around the at least the portion of the small form factor pluggable connector; and
an outer perimeter,
wherein at least one of: the inner perimeter or the outer perimeter is engraved with a lattice pattern, the lattice pattern being configured to dissipate heat.

18. The apparatus of claim 17, wherein the tube comprises:
a first arm having a c-shaped cross section;
a second arm having a c-shaped cross section; and
a hinge connecting an end of the first arm to an end of the second arm, so that the tube takes a form of a rectangular tube having four sides when a free end of the first arm is pivoted, via the hinge, toward a free end of the second arm.

19. The apparatus of claim 18, further comprising:
a latch positioned on a side of the four sides that is opposite a side of the four sides on which the hinge is positioned, to hold the tube in a closed position.

20. The apparatus of claim 17, wherein the lattice pattern comprises a hexagonal lattice pattern.
